(19) United States
(12) Patent Application Publication
(10) Pub. No.: US 2026/0229875 A1
(43) Pub. Date: Aug. 6, 2026

(54) POWER CONVERTER ARRANGEMENT WITH DC LINK

(71) Applicant: Siemens Aktiengesellschaft, München (DE)

(72) Inventor: Benno Weis, Hemhofen (DE)

(73) Assignee: Siemens Aktiengesellschaft, München (DE)

(21) Appl. No.: 19/147,216

(22) PCT Filed: Dec. 5, 2023
(86) PCT No.: PCT/EP2023/084286

§ 371 Date: Jul. 10, 2025

(30) Foreign Application Priority Data
Jan. 11, 2023 (EP) 23151158.5

(51) Int. Cl. H02H 7/122; H02M 7/537

(52) U.S. Cl. CPC H02H 7/122; H02M 7/537

(57) ABSTRACT

A power converter arrangement includes a DC link having a first phase and a second phase, a power converter connected between the first phase and the second phase so that a separate pair of connection nodes is associated with the power converter, a first DC link capacitor connected between the first phase and the second phase so that the power converter forms a buffer circuit with the first DC link capacitor, a first fuse associated with the power converter and connected within the buffer circuit of the power converter in series with the power converter, and a second DC link capacitor connected in parallel with the power converter within the buffer circuit. The second DC link capacitor is connected via two connection nodes, with one of the two connection nodes being arranged between the first fuse and the power converter.

The present invention relates to a power converter arrangement comprising a DC link with a first phase and a second phase as well as a plurality of power converters each of which is connected between the first phase and the second phase so that the individual power converters are each associated with a separate pair of connection nodes.

From the prior art, various power converter arrangements are known, having DC links, in particular, in the field of frequency converters, in which a plurality of inverters are operated on a common DC link. These individual inverters can electrically supply a plurality of consumers with an AC voltage. It is therein generally desirable to protect the Individual inverters separately so that in the event of a fault in an individual inverter, the affected branch between the associated connection nodes can be isolated separately from the DC link, wherein the other inverters and the associated consumer still remain operational. For this purpose, with known arrangements, separate fuses are typically provided in the individual branches.

Furthermore, according to the prior art, so-called DC link capacitors are typically provided in the individual branches of the DC link in order to smooth the DC voltage and to prevent severe voltage oscillations. These DC link capacitors are connected in parallel with the inverters within the individual branches so that, in each case, a buffer circuit is formed which extends across the inverter and the associated DC link capacitor. In conventional arrangements, the fuses of the individual branches are arranged outside these buffer circuits so that the connection point for the respective DC link capacitor is thus arranged on the side of the respective fuse facing toward the inverter. This has the advantage that the inductance within each buffer circuit can be kept very low. The limitation of the inductance within the buffer circuits is generally desirable to prevent the occurrence of excessively high voltage peaks caused by the switching processes in the inverters.

A disadvantage with the known power converter arrangements, however, is that in the event of a short circuit within a branch, not only the associated fuse, but also the fuse of one or more other branches can be tripped. Thus, in the event of a fault in one branch, prior damage to the fuses in the adjacent branches that are not at all affected by the fault can also occur. This problem is described in greater detail below making reference to FIG. 1. This disadvantage is particularly severe if consumers with very different nominal power ratings are used within a power converter arrangement. A consequence thereof is that in conventional power converter arrangements, it is usually only inverters and consumers with similar nominal power ratings that are operated with a shared DC link. However, this leads to severe restrictions in the design of the arrangements.

From EP 3 734 783 A1, a DC bus having a plurality of inverters in separate branches is known, wherein each branch has a capacitor which forms a buffer circuit with the respective inverter. Outside each buffer circuit, each branch has a fuse and a voltage sensor connected in parallel therewith.

From DE 11 2017 003081 T 5, also, a DC circuit with a plurality of parallel branches is known, wherein a capacitor which forms a buffer circuit with an associated load is arranged in each branch. Within each buffer circuit, each branch has a switch and a current sensor so that in the event of a fault caused by an arc, the affected branch can be isolated.

It is an object of the invention to provide a power converter arrangement which overcomes the stated disadvantages. In particular, a power converter arrangement is to be provided which enables a separate protection of the individual power converters and consumers, wherein the risk of prior damage to adjacent fuses is effectively reduced.

This object is achieved by way of the power converter arrangement described in claim 1. The power converter arrangement according to the invention comprises a DC link with a first phase and a second phase. It further comprises a plurality of power converters which are each individually connected between the first phase and the second phase so that a separate pair of connection nodes is associated with each of the individual power converters. Furthermore, it comprises at least one first DC link capacitor which is connected between the first phase and the second phase so that the power converters each form a buffer circuit with a first DC link capacitor. In addition, it comprises a first fuse associated with each power converter, said fuse being connected within the buffer circuit associated with each power converter, in series with the respective power converter. The power converter arrangement comprises, for each individual power converter, an associated second DC link capacitor. This is connected in parallel with the respective power converter within the associated buffer circuit. Therein, the second DC link capacitors are each connected via two associated connection nodes of which one is arranged between the first fuse and the power converter.

By way of the separate connection nodes, therefore, individual branches are formed in which the power converters are each linked individually to the DC link. The power converters are electrically connected in parallel with one another. The individual branches are separately protected via the first fuses associated with the individual power converters. For this purpose, the individual fuses are suitably connected within the respective branches. The at least one first DC link capacitor serves for buffering charges and thus for smoothing the DC voltage within the DC link. A plurality of variants are possible, as described in greater detail below. Thus, for example, in each branch, a separate first DC link capacitor can be present, by way of which the DC voltage is separately smoothed in the associated branch. In this variant, a separate buffer circuit is provided in each branch. Alternatively, however, a higher-level first DC link capacitor can be present which is provided for smoothing the DC voltage in a plurality of branches. In this case also, a buffer circuit is provided in each branch, although it is not then restricted to the respective branch, but extends via parts of the respective branch and the externally placed higher-level first DC link capacitor. In each case, the so-called “buffer circuit” should be understood to be the circuit that is formed by the respective power converter and the associated first DC link capacitor that buffers the charge, and via which the DC voltage is smoothed by means of the charge balancing from the DC link capacitor. In embodiments in which a plurality of DC link capacitors are associated with the respective power converter, the so-called “buffer circuit” should be understood to be the circuit that is formed by the power converter affected and the respective largest DC link capacitor that is present. Optionally provided further DC link capacitors then do not serve primarily for smoothing the DC voltage, but rather have other functions. In other words, the first DC link capacitor for a particular branch should always be the capacitor with the greatest capacitance, which balances the charges for this branch, and the buffer circuit accordingly extends via this largest DC link capacitor.

It is of crucial importance in the present invention that the first fuse associated with the respective power converter is arranged within the relevant buffer circuit. The advantage thereof is that by way of this arrangement, prior damage to fuses due to a fault in an adjacent branch can be effectively prevented. As distinct from the conventional power converter arrangements described, it is herein accepted that by way of the first fuses, an additional contribution to the inductance arises within the respective buffer circuit. This can lead to higher surge voltages on switching the associated power converter. In order to counteract this problem, either the individual components can be configured to be more robust against such surge voltages or optionally, further measures can be taken to reduce the surge voltages.

The invention is therefore based upon the recognition that the advantage of the arrangement described can justify, with regard to the reliable separate protection of the individual branches, the introduction of the first fuses as additional components within the respective buffer circuits. In particular, the advantages of the separate protection outweighs the disadvantages of the additional inductance above all in cases in which the individual power converters and the associated consumers have very different nominal power ratings. In conventional arrangements, large differences in the nominal power ratings are often not attainable without the risk, in the event of a fault, that the fuses in adjoining branches would be damaged.

The first fuse of the branch in question is arranged between the associated first and second DC link capacitors. The buffer circuit already described above is formed by way of the power converter and the first DC link capacitor. Accordingly, the power converter forms a so-called commutation circuit with the second DC link capacitor. Each first DC link capacitor serves to smooth the DC voltage, while each second DC link capacitor serves to reduce the transient surge voltages during the switching processes.

Advantageous embodiments and developments of the invention proceed from the claims dependent upon claim 1 and the description below.

Thus, the power converter arrangement according to an advantageous embodiment can have a frequency converter arrangement, wherein the individual power converters are each configured as inverters. In frequency converter arrangements of this type, there is often a need for a plurality of consumers to be driven with inverters on a common DC link. The common DC link can then be fed via a higher-level mains feed from an AC mains network. It is therein often required to protect the individual branches with the respective inverters separately and it can be desirable to operate inverters or consumers with different nominal power ratings on the common DC link. Specifically in applications of this type, the advantages of the invention have their effect.

Alternatively, however, the individual power converters of the power converter arrangement can also be configured as DC-to-DC converters. They can serve, in particular, to supply individual consumers from a common DC link with a DC voltage adapted to the consumer in each case.

According to a further alternative, the power converter arrangement can also be configured, for example, as an interruption-free power supply for a plurality of consumers. In general, a large number of applications is possible. What is important with the present invention is only that a plurality of power converters (that is, for example, Inverters or DC-to-DC converters) is supplied by way of a common DC link.

According to a generally advantageous embodiment, the first fuses associated with the respective power converters each have a tripping threshold, wherein at least two of the first fuses provided can differ in their tripping threshold by at least a factor of five. Such a different tripping threshold is suitable especially if the nominal power ratings of the optionally present consumers that can be supplied by the power converters are similarly different. Specifically, the arrangement according to the invention of the first fuses within the respective buffer circuit enables a reliable separate protection of the individual branches, even if the nominal power ratings for these branches differ widely from one another. There thus arises a significantly greater degree of freedom in the configuration of a higher-level system than would be possible according to the prior art.

In general, the respective power converter can be connected or be able to be connected to an associated electrical consumer, wherein each consumer is characterized by a rated current. In particular, each first fuse can have a tripping threshold that is in a range between 1.1-times and 1.5-times the rated current of the associated consumer. In other words, each first fuse is dimensioned to the rated current of the associated consumer and, particularly advantageously, can be approximately 30% above its rated current in order to trip reliably in the event of a fault. In this embodiment, the advantages of the invention have a particularly strong effect if at least two of the consumers differ with regard to their rated currents by at least a factor of 5. In conventional configurations, this would be difficult to implement without running the risk that in the event of a fault in a selected branch, the fuses of the other branch are also damaged.

In general, the consumers can be, for example, electrical machines, in particular, drive motors in an industrial system.

According to a first advantageous embodiment variant for the DC link capacitors, a separate first DC link capacitor can be associated with each of the individual power converters so that, by way of the respective power converter and the associated DC link capacitor, an independent buffer circuit is formed which is situated, in particular, fully within the associated branch. These independent buffer circuits accordingly do not extend beyond their associated connection nodes. Or, expressed differently, the respective first DC link capacitor is connected via the same two connection nodes to the DC link as the associated power converter. Thus, there is also no overlap between the individual buffer circuits that are associated with the individual power converters, but rather they are spatially completely separated from one another. The advantage of this embodiment is that the individual branches are also electrically largely separated from one another and that, in particular, in the event of a fault, only a slight electrical interaction takes place between one branch affected by a fault and the adjacent branch.

According to an alternative advantageous embodiment variant, the power converter arrangement comprises a higher-level first DC link capacitor which is connected via separate connection nodes between the first phase and the second phase. This higher-level DC link capacitor therefore serves to smooth the DC voltage in a plurality of branches and thus for a plurality of power converters. Accordingly, for each of these power converters, not only does the associated buffer circuit extend across the associated branch, but also across the common first DC link capacitor. In this way, the individual buffer circuits overlap spatially and each include the jointly used first DC link capacitor. The dimensioning of the higher-level first DC link capacitor is suitably such that thereby the DC voltage can be sufficiently smoothed for all the branches. For example, a value can be selected for its capacitance which corresponds approximately to the sum of the individual capacitances that would be selected for the separate DC link capacitors of the embodiment described above. An advantage of the embodiment variant with a common, higher-level DC link capacitor lies in that fewer components are needed overall and thus also fewer connections are needed and a space-saving circuit can be realized.

According to a generally advantageous embodiment for the arrangement of the fuses, the power converter arrangement can comprise one or more second fuses which are arranged outside the individual buffer circuits. These additional fuses correspond to the fuses in the power converter arrangements that are known from the prior art. In the embodiment according to the invention, they are optional. If they are present, they serve for the protection of the respective first DC link capacitors in the event of a fault in the higher-level DC link or for the separation of the branch from the higher-level DC link in the event of a short-circuit in a first DC link capacitor. It is therefore suitable if, in an embodiment variant with an individual first DC link capacitor for each branch, a separate second fuse is present per branch in order to protect it. In general, for each power converter, an associated second fuse can be provided which is electrically connected between the associated buffer circuit and one of the two associated connection nodes.

In an embodiment with a higher-level first DC link capacitor for all the branches, however, it is sufficient if a higher-level second fuse is present for its protection. Thus, the power converter arrangement can have a higher-level mains feed and a higher-level second fuse which is electrically connected between the entirety of the connection nodes of the power converter and the higher-level mains feed.

In general and independently of the arrangement and the number of the second fuses, it is advantageous if the at least one second fuse has a tripping threshold that is higher than the tripping thresholds of the existing first fuses. If a plurality of second fuses is present, it is sufficient if each second fuse is dimensioned higher than the associated first fuse (thus it does not have to be dimensioned higher than all the first fuses). In other words, within each branch, the second fuse then has a higher tripping threshold than the first fuse. An advantage of this embodiment with a higher dimensioned second fuse is that in the event of a fault in one of the branches, initially the first fuse of this branch is tripped and the second fuse remains unimpaired. Thus, in the event of a local fault in the inverter and/or consumer in one of the branches, only the exchange of the associated first fuse within the buffer circuit is needed. Particularly suitably, the tripping threshold of the respective second fuse can be higher by a factor of at least 2 than the tripping threshold of the associated first fuse,

Alternatively to the embodiments described above, it is also possible, however, that no second fuse is present, in other words, that within the DC link only the first fuses are present which are placed within the respective buffer circuits and in that no additional fuses are provided outside the buffer circuits. In the event of a fault in one of the first DC link capacitors, a central fuse of the power converter arrangement can then trip, for example, a central fuse between a mains feed and a higher-level AC mains network, from which the DC link is electrically supplied.

Each second DC link capacitor suitably has a lower capacitance than the first DC link capacitor associated with the respective power converter. The spatially larger buffer circuit of each branch therein includes the associated first fuse, whereas the first fuse is arranged outside the spatially more restricted commutation circuit. The capacitance of each second DC link capacitor can even be significantly lower than the capacitance of the associated first DC link capacitor. For example, it can be lower by at least a factor of 10 and, in particular, even at least a factor of 100. By way of this greatly differing dimensioning of the first and the second DC link capacitor, what is achieved is that on recharging of the second DC link capacitors (e.g. in the event of a fault), the second fuses arranged outside the respective commutation circuit are not tripped. It is therefore generally advantageous if the charge stored in the second DC link capacitors is not sufficient to trip the associated first fuses in the event of a short-circuit. By this means, unnecessary damage to these first fuses can be prevented. Rather they only trip if a recharging of the correspondingly significantly higher dimensioned first DC link capacitor takes place. With regard to the respective first DC link capacitor, however, the associated first fuse is arranged within the buffer circuit so that only the first fuse of the respective affected branch is tripped and not the corresponding first fuse in an adjacent branch.

The invention will now be described using several preferred exemplary embodiments and making reference to the attached drawings, in which

FIG. 1 shows a schematic equivalent circuit diagram of a power converter arrangement according to the prior art,

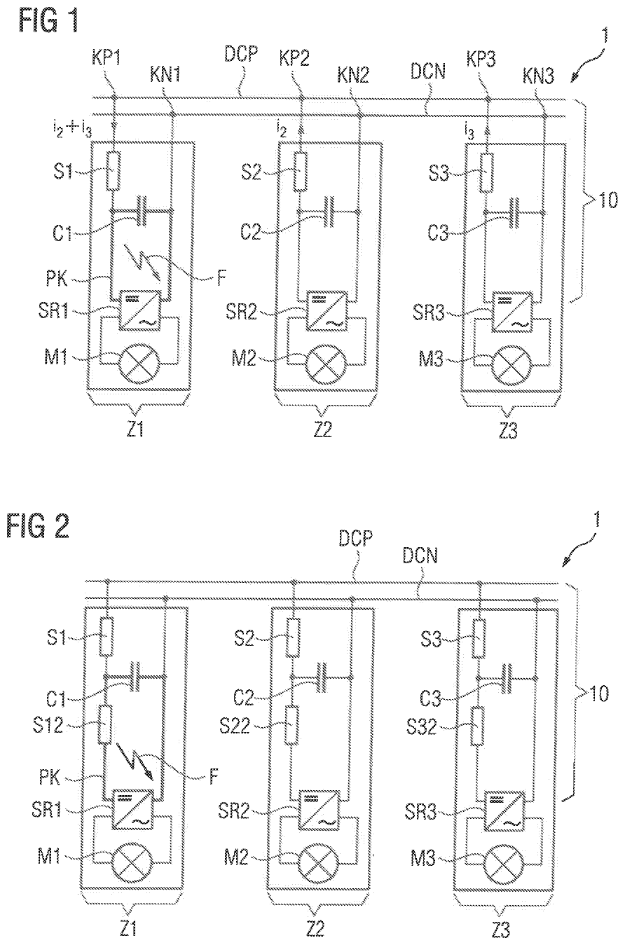

FIG. 2 shows a further exemplary power converter arrangement,

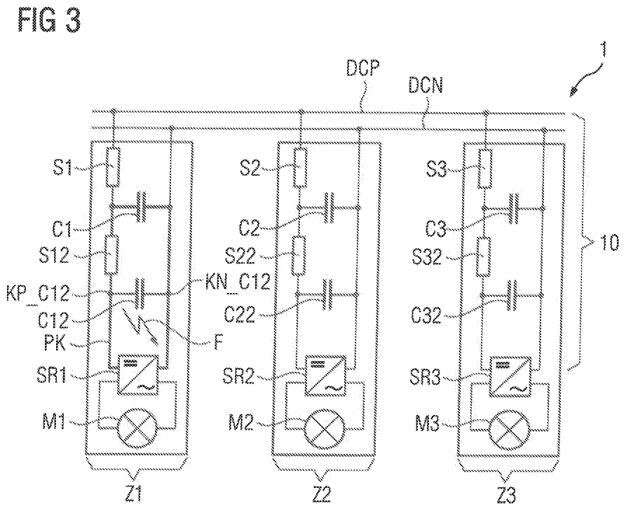

FIG. 3 shows a power converter arrangement according to one example of the invention, and

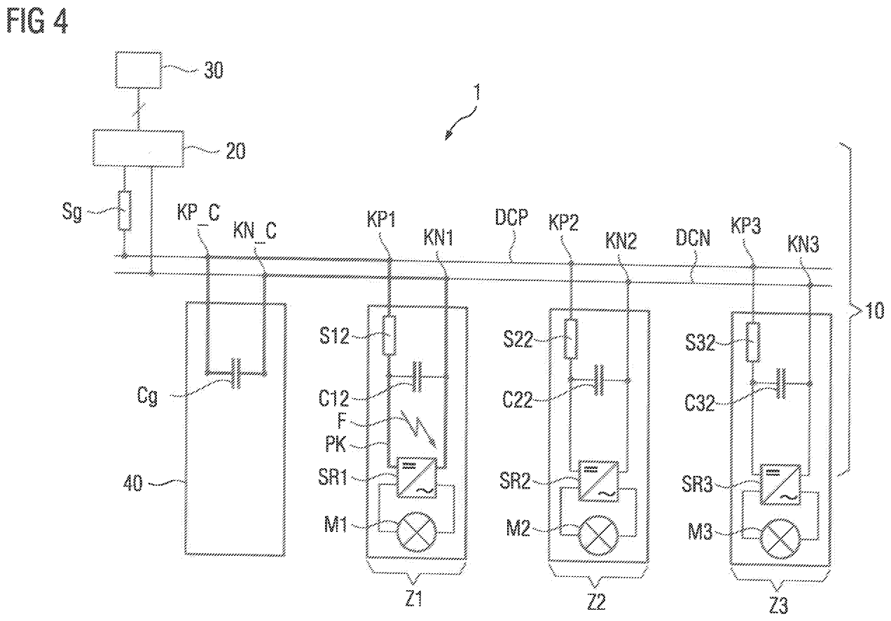

FIG. 4 shows a power converter arrangement according to a further example of the invention.

In the figures, the same or functionally equivalent elements have been given the same reference signs.

FIG. 1 shows a schematic equivalent circuit diagram of a power converter arrangement 1 according to the prior art. This is a frequency converter arrangement in which a plurality of power converters SR1, SR2, SR3 are connected to a common DC link 10. The individual power converters SR1, SR2 and SR3 are herein configured as inverters and each convert the DC voltage of the DC link 10 into an AC voltage. In the arrangement shown, each of the three inverters SR1, SR2, SR3 is connected to an associated consumer M1, M2, M3, wherein each consumer M1, M2, M3 is supplied by the inverter SR1, SR2, SR3 with a suitable AC voltage. These three consumers M1, M2, M3 can be, for example, drive motors of an industrial production system.

The DC link 10 comprises two phases, specifically a first phase DCP with positive polarity and a second phase DCN with negative polarity. The DC link 10 is supplied with DC current by a higher-level mains feed (not shown here), wherein the mains feed comprises, in particular, a rectifier which itself is connected to an AC mains network. Thus, a DC voltage is applied between the two phases DCP and DON. The individual inverters SR1, SR2, SR3 are each connected via separate pairs of connection nodes to the two phases, for example, the first inverter SR1 via the two connection nodes KN1 and KP1. Thus, in this example, three independent branches Z1, Z2 and Z3 are formed. In general, more or fewer such branches can be provided. Within each branch, a DC link capacitor C1, C2, C3 is connected in parallel with the respective inverter SR1, SR2, SR3. Thus, for example, in the first branch Z1, the DC link capacitor C1 together with the first inverter SR1 forms a buffer circuit PK, by means of which the DC voltage applied to the first inverter SR1 is smoothed. The buffer circuit PK is marked with a bold printed line. A fuse S1 is connected between the DC link capacitor C1 and one of the associated connection nodes-in this case, for example, KP1. In the event of a fault F, thus, for example, a short-circuit in the first branch Z1, this fuse S1 can trip and thereby isolate the affected power converter SR1 and the consumer M1 fed by it from the mains. The electrical arrangement in the other branches is similar.

A problem with this arrangement according to the prior art is that in the event, by way of example, of the fault F as shown in the first branch Z1, the corresponding fuses S2 and S2 in the adjacent branches Z2 and Z3 can trip unintendedly, even if no fault has occurred in these branches Z2, Z3. If, in the first branch Z1, a fault F occurs at the site indicated by the arrow, the DC link capacitor C1 of this branch Z1 discharges into the fault state. In addition, however, the corresponding DC link capacitors C2 and C3 of the adjacent branches Z2, Z3 discharge into the fault state. Therein, the discharge current i₂ flows in the second branch Z2, and the discharge current i₃ flows in the third branch Z3, and the total of the discharge currents i₂, i₃ flows via the fuse S1 of the first branch Z1. In particular, when the adjacent fuses S2 and S3 are dimensioned for a relatively low rated current, in the event of a fault in the first branch Z1, the fuses S2 and/or S3 can also be tripped by these discharging processes, Such a false tripping of a fuse S2, S3 in an adjacent branch Z2, Z3 is undesirable since thereby a repair or an exchange of a fuse S2, S3 in a branch Z2, Z3 that was not at all affected by the original fault F becomes necessary. In a similar way, fuses S1, S2, S3 of the individual branches Z1, Z2, Z3 can trip spuriously if a fault occurs in a further outlying region (not shown here) of the DC link 10. In order to restrict the problem described of spurious trippings of fuses, in the case of such conventional arrangements, it is mostly only power converters SR1, SR2, SR3 and consumers M1, M2, M3 with mutually relatively similar nominal power ratings that are operated on a common DC link.

In FIG. 2, a corresponding equivalent circuit diagram for a further power converter arrangement 1 is shown. Here also, the power converter arrangement 1 is a frequency converter arrangement with a plurality of power converters SR1, SR2, SR3, each of which is configured as an inverter, The distribution into three separate branches Z1, Z2, Z3 is also made accordingly. However, as distinct from the conventional arrangement of FIG. 1, here in each of the branches Z1, Z2, Z3, a first fuse S12, S22, S32 is connected between each DC link capacitor C1, C2, C3 and the associated power converter SR1, SR1, SR3. This first fuse S12, S22, S32 is therefore arranged within the respective buffer circuit PK. Purely as an option, another second fuse S1, S2, S3 which then corresponds to the fuses from the arrangement of FIG. 1 can be arranged outside the respective buffer circuit PK. However, this is not necessarily required. What is essential is that in each branch Z1, Z2, Z3, the respective first fuse S12, S22, S32 is arranged within the respective buffer circuit PK. This first fuse S12, S22, S32 has, in particular, a lower tripping threshold than the optionally provided second fuse S1, S2, S3 of the respective branch Z1, Z2, Z3, such that, for example, the tripping threshold of the first fuse S12 is lower than the tripping threshold of the second fuse S1.

In the arrangement of the example of FIG. 2, In the event of a fault F in the first branch Z1, the first fuse S12 is not tripped by the current from the DC link capacitors C2 and C3 of the adjacent branches Z2, Z3, but above all by the current from the DC link capacitor C1 of the associated branch Z1. Since the most sensitive fuse S12, S22, S32 in each branch Z1, Z2, Z3 is arranged within the buffer circuit PK, firstly this fuse S12 trips and separates the affected fault site from the other branches before a substantial current flow can take place out of the DC link capacitors C2, C3 of the adjacent branches Z2, Z3. Thus unwanted damage to fuses S22, S32 in adjacent branches Z2, Z3 is effectively prevented. The optionally provided second fuses S1, S2, S3 which are herein arranged outside the respective buffer circuit PK are also less at risk since they are, firstly, dimensioned higher and, secondly, the current flow in this region in the event of a fault F is interrupted very quickly by the tripping of the associated first fuse S12, S22, S32. Thus, the extent of the repairs needed following a fault can be effectively restricted. It is also possible to realize arrangements with substantially more severely differing nominal power ratings and correspondingly different nominal currents in the individual branches Z1, Z2, Z3 without the risk of the undesirable tripping of fuses therein becoming too great.

The second fuses S1, S2, S3 situated outside the respective buffer circuit PK serve to protect the respective associated DC link capacitors C1, C2 or C3. If their failure rate is correspondingly low, the second fuses S1, S2, S3 can also be dispensed with entirely. Instead of this, in the event of a fault in one of the DC link capacitors C1, C2, C3, for example, a central fuse (not shown here) of the higher-level DC link 10 can trip and/or a central fuse on the AC voltage side of a higher-level mains feed can trip.

FIG. 3 shows a corresponding equivalent circuit diagram for a power converter arrangement 1 according to an exemplary embodiment of the invention. The underlying structure is similar to that of the power converter arrangement of FIG. 2. In contrast thereto, an additional second DC link capacitor C12, C22, C32 is also arranged in each branch Z1, Z2, Z3. This second DC link capacitor C12, C22, C32 is connected in parallel with the respective power converter SR1, SR2, SR3 within the associated buffer circuit PK. The second DC link capacitors C12, C22, C32 are each connected via two associated connection nodes (e.g. the connection nodes KP_C12 and KN_C12 for the DC link capacitor C12), wherein one of these connection nodes (in this case KP_C12) is arranged between the associated first fuse S1 and the associated power converter SR1. In other words, each second DC link capacitor C12, C22, C32 is arranged on the power converter side of the associated first fuse S12, S22, S32. Each second DC link capacitor C12, C22, C32 has a lower capacitance than the associated first DC link capacitor C1, C2, C3 of the respective branch Z1, Z2, Z3, According to the definition, the so-called buffer circuit PK extends via the first DC link capacitor C1, C2, C3 and not via the second DC link capacitor C12, C22, C32 and the respective first fuse S12, S22, S32 is arranged within the buffer circuit PK that is formed. The higher dimensioned first DC link capacitor C1, C2, C3 fulfils the function In each branch Z1, Z2, Z3 of smoothing the DC voltage within the buffer circuit PK, whereas each second DC link capacitor C12, C22, C32 serves substantially to reduce surge voltages associated with the switching processes in each power converter SR1, SR2, SR3. This addresses a difficulty that can arise due to the arrangement according to the invention of the first fuses S12, S22, S32 within the respective buffer circuits PK: Due to the additional inductance caused by the placement of the first fuse S12, S22, S32 within the respective buffer circuit PK, during the switching processes, significantly higher surge voltages can arise than is the case in the conventional arrangement of FIG. 1 if it is implemented with very low total inductances in the individual buffer circuits. This fundamental disadvantage of the arrangement according to the invention of the first fuses S12, S22, S32 can be effectively lessened or even resolved by way of the additional second DC link capacitors C12, C22, C32.

FIG. 4 shows a corresponding equivalent circuit diagram for a power converter arrangement 1 according to a further exemplary embodiment of the invention. Herein also, a plurality of branches Z1, Z2, Z3 is present, in each of which a power converter SR1, SR2, SR3 (also configured here as an inverter) is arranged. As distinct from the two foregoing examples, however, the first DC link capacitor C1, C2, C3 for smoothing the DC voltage is not arranged within the individual branches Z1, Z2, Z3, but rather in a separate capacitor module 40 which is connected via separate connection nodes KP_C and KN_C to the DC link 10. Arranged in the capacitor module 40 is a higher-level first DC link capacitor C_{g} which serves for smoothing the DC voltage in all the branches Z1, Z2, Z3 that are present. Here also, additional second DC link capacitors C12, C22, C32 are provided within the individual branches Z1, Z2, Z3, although they have significantly smaller capacitances than the higher-level first DC link capacitor C_{g}. Therefore, the buffer circuit PK for each power converter SR1, SR2, SR3—which is defined as the associated power circuit for charge buffering with the greatest capacitance-extends via the first DC link capacitor C_{g} situated outside the respective branch Z1, Z2, Z3. By way of example, the corresponding buffer circuit PK for the first branch Z1 is marked with a bold line. The buffer circuits of the remaining branches Z2, Z3 are formed accordingly so that the individual buffer circuits overlap spatially in the region of the higher-level first DC link capacitor C_{g}.

Also, in the example of FIG. 4, each of the individual branches Z1, Z2, Z3 has an associated first fuse S12, S22, S32 which is arranged within the respective buffer circuit PK. Here also therefore, in the event of a fault F in one of the branches (here, for example in Z1), what is therefore achieved is that the associated fuse S12 trips and electrically isolates the affected branch Z1, wherein the higher-level first DC link capacitor C_{g} discharges into the fault site. Thereby, prior damage to the fuses S22, S32 in the adjacent branches Z2, Z3 is effectively prevented, since no significant discharging currents flow here. Similarly to the example of FIG. 3, herein also the second DC link capacitors C12, C22, C32 are dimensioned smaller with respect to their capacitance than the higher-level first DC link capacitor C_{g} and substantially serve to equalize rapidly surge voltages caused by the switching processes in the individual power converters SR1, SR2, SR3.

Optionally, with such an embodiment, a higher-level second fuse S_{g} can also be provided. Similarly to the example of FIG. 3, this second fuse S_{g} is arranged outside the individual buffer circuits PK and its tripping threshold is higher than the tripping thresholds of the respective first fuses S12, S22, S32. As distinct from the previous example, however, in this case, only one such second fuse S_{g} is present, which serves as a higher-level fuse for all the branches Z1, Z2, Z3. Accordingly, it is connected between the totality of the connection nodes KN1, KP1, KN2, KP2, KN3, KP3 of the power converters SR1, SR2, SR3 and a higher-level mains feed 20. The higher-level mains feed 20 serves to supply the entire DC link 10 with a DC voltage. For this purpose, it can have a rectifier and be fed from an AC mains network 30.

The embodiments described are to be understood as purely exemplary. In a similar manner, the advantages of the invention can also be realized with other power converter arrangements in which other types of power converters are used. Thus, the individual power converters can alternatively be configured, for example, as DC-to-DC converters which are fed by a common DC link. Or, it can be an interruption-free power supply with a higher-level DC circuit. In addition, the branches Z1, Z2, Z3, similarly to the embodiment of FIG. 3, which contain a first DC link capacitor C1, C2, C3, and branches Z1, Z2, Z3 corresponding to FIG. 4, which contain no first DC link capacitor C1, C2, C3, can be connected in parallel with one another as desired. In this case, the branches Z1, Z2, Z3 of the embodiment of FIG. 3, which contain a first DC link capacitor C1, C2, C3, can also adopt the functionality of the capacitor module 40 of FIG. 4.

1.-11. (canceled)

12. A power converter arrangement, comprising:
a DC link having a first phase and a second phase;
a power converter connected between the first phase and the second phase such that a separate pair of connection nodes is associated with the power converter;
a first DC link capacitor connected between the first phase and the second phase so that the power converter forms a buffer circuit with the first DC link capacitor;
a first fuse associated with the power converter, said first fuse being connected within the buffer circuit of the power converter in series with the power converter; and
a second DC link capacitor connected in parallel with the power converter within the buffer circuit, said second DC link capacitor being connected via two connection nodes, one of the two connection nodes being arranged between the first fuse and the power converter.

13. The power converter arrangement of claim 12, constructed as a frequency converter arrangement comprising a plurality of said power converter, with each individual one of the plurality of power converters being designed as an inverter.

14. The power converter arrangement of claim 12, comprising a plurality of said power converter and a plurality of said first fuse associated with the power converters, respectively, wherein the first fuses have each a tripping threshold, with at least two of the first fuses differing with regard to their tripping threshold by at least a factor of 5.

15. The power converter arrangement of claim 12, comprising a plurality of said power converter and a plurality of said first DC link capacitor associated to the power convertors, respectively, wherein each of the power converters and a dedicated one of the first DC link capacitors form an independent buffer circuit.

16. The power converter arrangement of claim 12, further comprising a higher-level DC link capacitor connected via separate connection nodes between the first phase and the second phase.

17. The power converter arrangement of claim 12, further comprising a second fuse arranged outside the buffer circuit.

18. The power converter arrangement of claim 17, wherein the first fuse has a tripping threshold, said second fuse having a tripping threshold that is at least a factor of 2 higher than the tripping threshold of the first fuse.

19. The power converter arrangement of claim 17, comprising a plurality of said power converter and a plurality of said second fuse associated with the power converters, respectively, wherein the second fuses are arranged electrically between the associated one of the buffer circuits and a corresponding one of the connection nodes.

20. The power converter arrangement of claim 12, comprising a plurality of said power converters connected between the first phase and the second phase so that separate pairs of connection nodes are associated with the power converters, respectively, the power converter arrangement further comprising:
a higher-level mains feed; and
a higher-level second fuse electrically arranged between an entirety of the connection nodes of the power converters and the higher-level mains feed.

21. The power converter arrangement of claim 12, wherein the second DC link capacitor has a capacitance which is lower than a capacitance of the first DC link capacitor.

22. The power converter arrangement of claim 12, wherein the second DC link capacitor has stored therein a charge insufficient to trip the first fuse in an event of a short-circuit.
